(19) United States
(12) Patent Application Publication
(10) Pub. No.: US 2009/0152944 A1
(43) Pub. Date: Jun. 18, 2009

(54) POWER SYSTEM

(75) Inventors: Tim Baine, Bonner Springs, KS (US); Lance Rake, Lawrence, KS (US); Michael J. Scherzer, Akron, OH (US); David Starr, Naperville, IL (US); Zach Utz, Uniontown, OH (US); Robert J. Warner, JR., Charlotte, NC (US)

Correspondence Address: MOORE & VAN ALLEN PLLC, P.O. BOX 13706, Research Triangle Park, NC, 27709, US

(73) Assignee: RUBBERMAID, INC., Huntersville, NC (US)

(21) Appl. No.: 12/178,402

(22) Filed: Jul. 23, 2008

Related U.S. Application Data
(60) Provisional application No. 60/962,112, filed on Jul. 26, 2007.

(51) Int. Cl. H02J 3/00; H02B 1/40

(52) U.S. Cl. 307/12; 174/494

(57) ABSTRACT

A power rail system comprises a rail for mounting on a surface and a device for providing power to the rail. An accessory releasably engages the rail and uses the power provided to the rail to power the accessory. The rail may also support non-powered accessories. In one embodiment the device for providing power to the rail comprises a power strip releasably mounted on the rail. The rail may include a first rail segment and a second rail segment where the device for providing power to the rail comprises a power strip located between the first rail segment and the second rail segment. The device for providing power to the rail may comprise an electrical conductor extending along a length of the rail. The electrical conductor is powered by a power module that connects to the rail. A power strip for use in the system is also provided.

This application claims benefit of priority under 35 U.S.C. § 119(e) to the filing date of to U.S. Provisional Application No. 60/962,112, as filed on Jul. 26, 2007, which is incorporated herein by reference in its entirety.

The invention relates to storage systems and more particularly to wall mounted storage systems.

### BACKGROUND

One such wall mounted storage system is sold by Newell Rubbermaid Inc. under the trademark FASTTRACK®. Such a system comprises a rail or a plurality of rails that are mounted to a substantially vertical supporting surface such as a wall. The rail supports a variety of organizing and storage accessories such as hooks, shelving units and tool holders. The accessories can be removed from and attached to the rail along its length such that the system provides a flexible, reconfigurable storage and organizing system.

### SUMMARY OF THE INVENTION

A power rail system comprises a rail for mounting on a surface and a device for providing power to the rail. An accessory releasably engages the rail and uses the power provided to the rail to power the accessory. The rail may also support non-powered accessories such as storage accessories. In one embodiment the device for providing power to the rail comprises a power strip releasably mounted on the rail. The rail may include a first rail segment and a second rail segment where the device for providing power to the rail comprises a power strip located between the first rail segment and the second rail segment. The device for providing power to the rail may comprise an electrical conductor extending along a length of the rail. The electrical conductor is powered by a power module that connects to the rail. A method of storing and powering accessories is also provided.

A rail for use in a storage system is also provided that supports an accessory. An electrical conductor extends along a length of the rail that is connectable to a source of power to provide power to the rail. The rail includes flanges that are engaged by the accessory. The rail may include a first rail segment and a second rail segment where an electrical connector is provided between the first rail segment and the second rail such that the first rail segment is electrically connected to the second rail segment such that power provided to one rail segment may be transmitted to the other segment.

A power strip for use in a system comprising a rail adapted to support a plurality of storage accessories is also provided. The power strip comprises a housing having means for connecting the housing to the rail. At least one power outlet is supported on the housing. An electrical connector connects the power outlet to a power source.

### BRIEF DESCRIPTION OF THE DRAWINGS

FIG. 1 is a plan view showing a power strip system.

FIG. 2 is a plan view showing a power strip system with a cord stored on the power strip.

FIG. 3 is a partial section view showing the power strip system of FIG. 1.

FIGS. 4 and 5 are alternate embodiments of a rail used in the system of FIG. 1.

FIG. 6 is a perspective view of an embodiment of a power to the rail system.

FIG. 7 is a perspective view of another embodiment of a power to the rail system.

FIG. 8 is a perspective view of an embodiment of a powered rail for use in a rail storage system.

FIG. 9 is an exploded view of the powered rail of FIG. 8 and a connector for such a rail.

FIG. 10 is a front perspective view of the connector of FIG. 9.

FIG. 11 is a back perspective view of the connector of FIG. 9.

FIG. 12 is an exploded view of the connector of FIG. 9.

FIG. 13 is a perspective view showing the interior of the connector of FIG. 9.

FIG. 14 is a perspective view showing the powered rail and connector in an assembled condition.

FIG. 15 is a side view an embodiment of a device for powering the rail.

FIG. 16 is a perspective view showing the device of FIG. 15 mounted on a rail.

FIG. 17 is a side view of another embodiment of a device for powering the rail.

FIG. 18 is a plan view showing the device of FIG. 17 mounted on a rail.

FIGS. 19 through 25 show accessories for use with the powered rail.

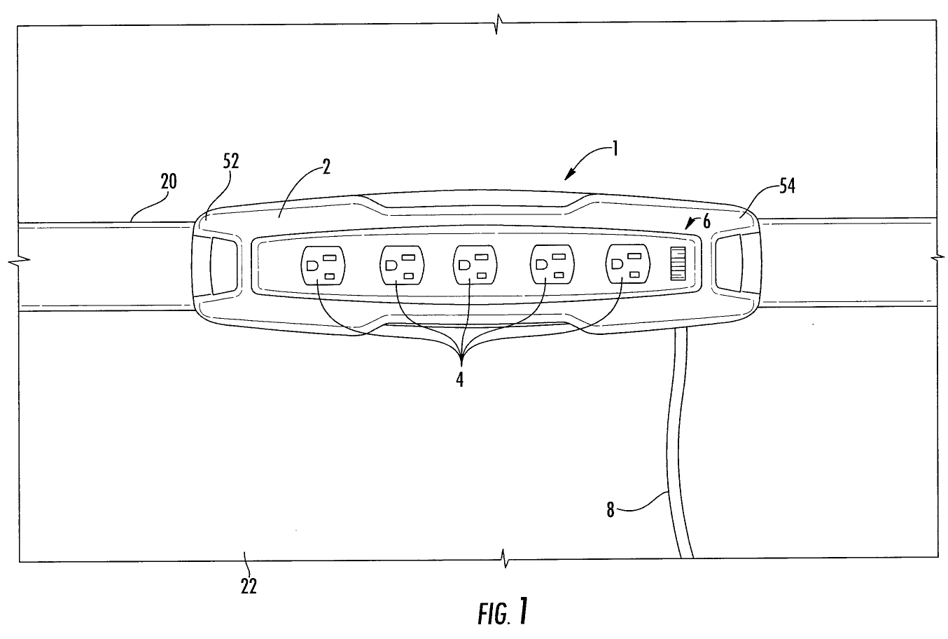

### DESCRIPTION OF EMBODIMENTS OF THE INVENTION

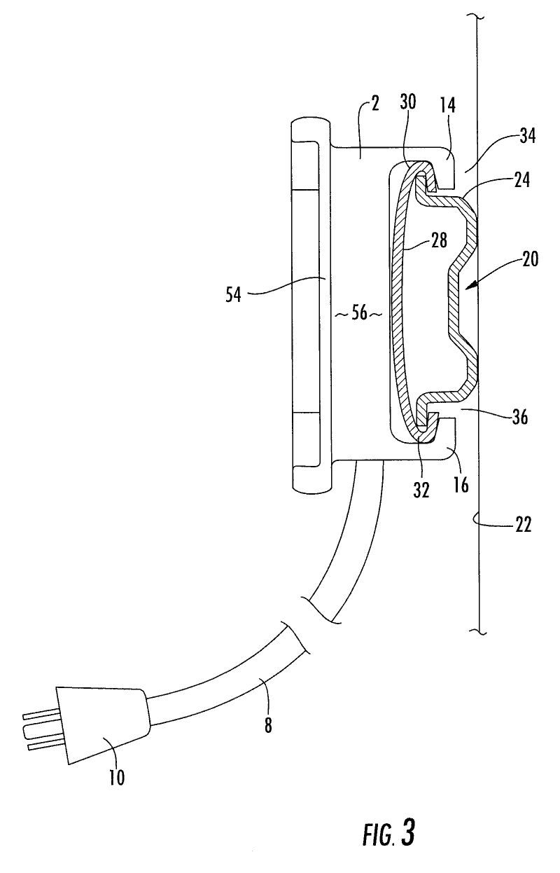

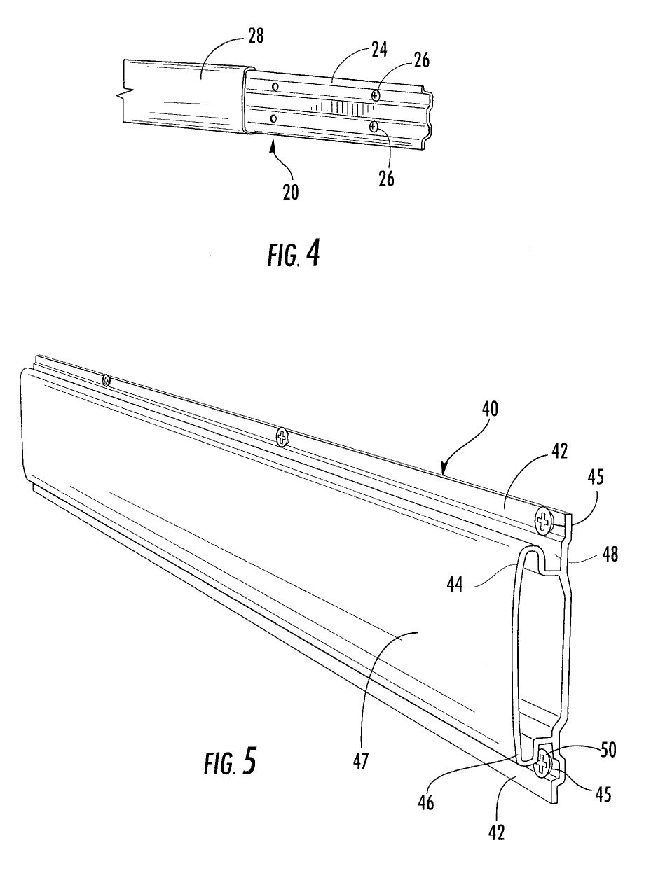

Referring to FIGS. 3 and 4 a rail 20 includes a rail portion 24 that is mounted on a wall or other substantially vertical surface by fasteners such as screws 26. Cover portion 28 slides or snaps over rail portion 24. The rail 20 defines an upwardly extending 30 flange and a downwardly extending flange 32 that define the define longitudinal recesses 34 and 36 between the rail 20 and the vertical surface 22 on which the rail is mounted.

An alternate one piece version of the rail is shown in FIG. 5 that includes a rail 40 having flanges 42 extending the length thereof for receiving screws 45 or other fasteners for mounting the rail 40 to a vertical surface 22. A centrally located protrusion 47 defines an upwardly extending flange 44 and a downwardly extending flange 46 that define longitudinal recesses 48 and 50 between the protrusion 47 and flanges 42.

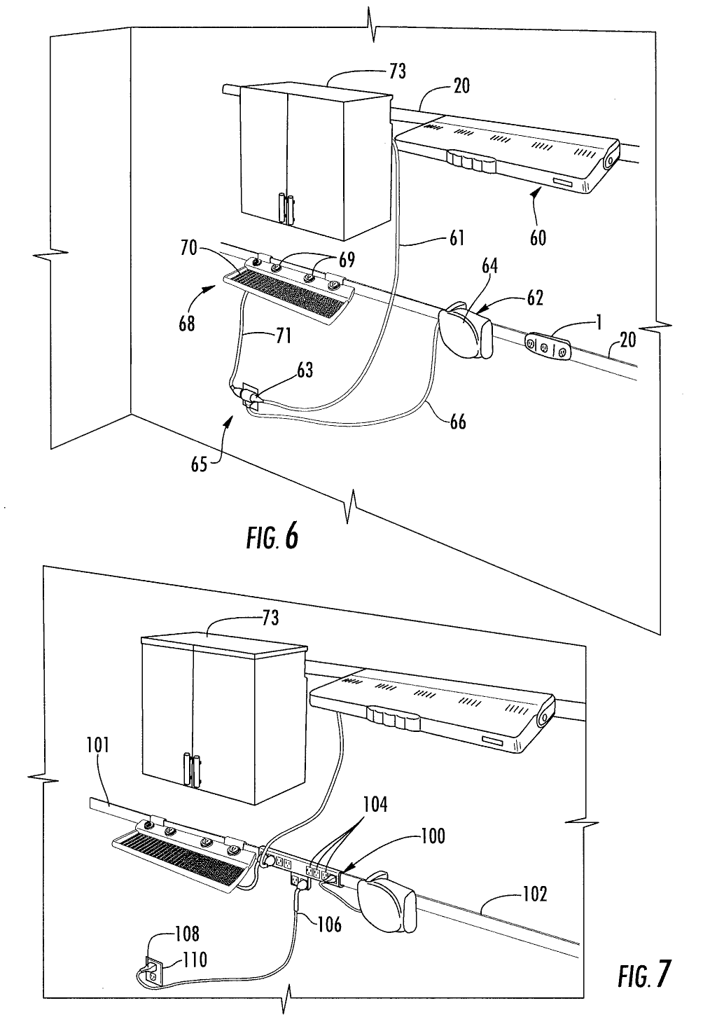

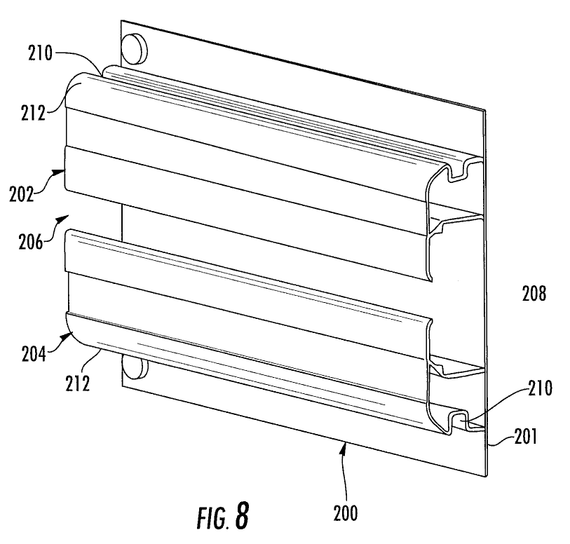

The rails 20, 40 are intended to support a wide variety of storage devices 73 (FIGS. 6 and 7) such as hooks, racks, tool holders, shelving units, cabinets and the like. While the storage device illustrated in FIGS. 6 and 7 is a cabinet such systems include a wide variety of storage devices that may be used to store and organize a wide variety of articles. One such system is the FASTTRACK® garage organization system sold by Newell Rubbermaid Inc.

A power strip for use in such a wall mounted storage system is shown generally at 1 in the figures and comprises a housing 2 that supports a plurality of outlets or sockets 4. In the illustrated embodiment, the sockets 4 are arranged in the front of housing 2 although the sockets 4 may be arranged in any position on the housing 2 provided that they can be accessed by a mating plug. The outlets or sockets 4 are able to receive mating standard plugs from electrical appliances such as extension cords, tools, lights or any other device that requires a source of electrical power. The power strip 1 may include a switch 6 to open and close the electrical circuit between the source of power and the outlets 4 to turn the outlets on and off. Each outlet 4 may also be individually switched. The power strip 1 may have built in surge protectors.

Referring to FIG. 3, extending from the back of the housing 2 are an upper flange 14 and a lower flange 16 where the flanges 14 and 16 that are dimensioned to releasably engage the rail 20. The flanges 14 and 16 flex to allow the housing to be snap fit onto the rail 20 such that the flanges 14 and 16 engage flanges 30 and 32 and extend into recesses 48 and 50. The housing 2 can be removed from the rail 20 and relocated at any position along the rail and/or slid over the rail.

To provide electrical power to the outlets 4, an electrical conductor such as cord 8 having a plug 10 formed at the end thereof is electrically coupled to the outlets 4. The plug 10 may be inserted into a wall outlet, such as a standard wall outlet in a home or garage, to provide electrical power to the power strip 1. The cord 8 and plug 10 may be replaced by wiring that is hard wired to the power source such as a building's electrical system. Housing 2 can engage rail 20 to mount the power strip on a vertical surface 22.

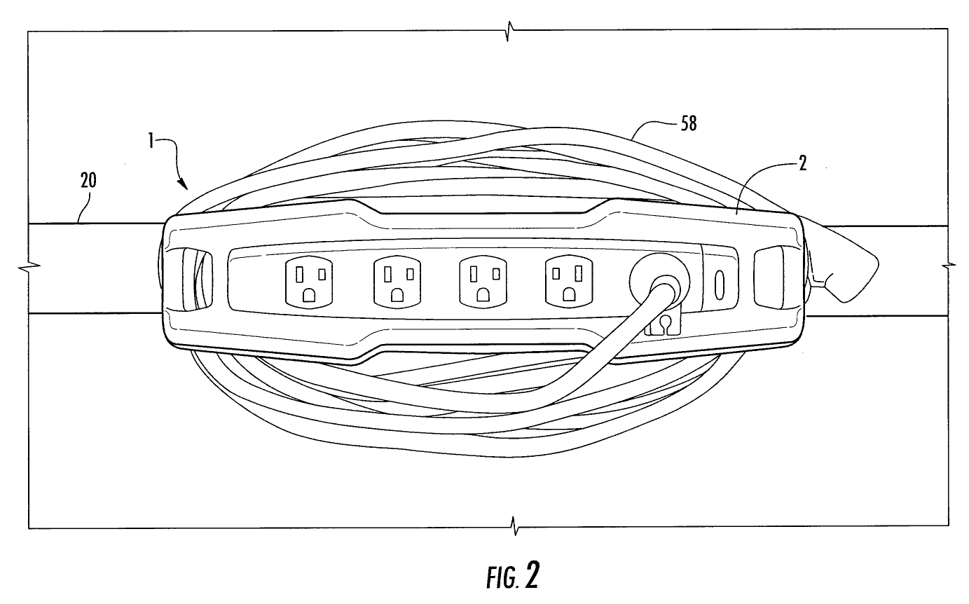

The housing 2 further includes a pair of members 52 and 54 that extend laterally from the ends of the housing 2 and define recesses 56 between the members and the rail for receiving a cord 56 such as an extension cord as shown in FIG. 2. The cord 56 can be wrapped around the housing between the members 52, 54 and the rail 20 for storage. While the cord 56 is illustrated as an extension cord any cord may be wrapped around the housing for storage including cord 8.

Other powered accessories may be connected to the rail in the same manner. Referring to FIG. 6, a light such as a fluorescent light 60 may be mounted to the rail 20 where an electrical cord 61 with a standard plug 63 that may be plugged into a receptacle such as wall outlet 65 to connect the light 60 to a source of electrical power. FIG. 6 also shows a retractable extension cord 62 mounted in a housing 64 where the housing is mounted on a rail 20. The extension cord may be wound in the housing 64 on a spool where the spool is wound by a spring, manual crank, electric motor or the like. Power is provided to the extension cord by an electrical cord 66 with a plug that may be plugged into a receptacle 65. Cord 66 may comprise one end of the extension cord or it may be a separate cord connected to the housing 64. FIG. 6 also shows a charging station 68 connected to the rail 20 that can be used to charge batteries from electrical appliances or tools. The charging station 68 includes electrical outlets 69 for receiving the plug from the battery charger of the tool or appliance. The charging station further includes a platform 70 on which the battery chargers, tools, appliances or the like be placed during the charging operation. Power is provided to the extension cord by an electrical cord 71 having a plug that may be plugged into receptacle 65. Note, the powered accessories may also be powered by electrically connecting the accessories to power strip 1 and connecting the power strip to the power source 65.

FIG. 7 shows an alternate design for powering the rail mountable electrical accessories. In the embodiment of FIG. 7 the electrical power is provided by a power module 100 that acts as a rail connector to connect a first rail 101 to a second rail 102.

The rails 101 and 102 may have a configuration as shown in FIG. 4 or 5 where the ends of the rail are open to expose internal cavities. The power module 100 is provided with male connectors that fit into cavities to secure the power module to the end of the rails. The power module 100 may have male connectors provided on both ends such that the power module functions to connect the rails 101 and 102 to one another. The power module 100 may be retained in the rails by a friction fit, by a mechanical connection such as a snap fit or by a separate connector such as a fastener such as a screw. The power module 100 is supported on the vertical surface generally within the profile of the rails 101 and 102.

To provide electrical power to the outlets 104, an electrical conductor such as cord 106 is electrically coupled to the outlets 104 internally of the power module 100. A plug 108 is attached to the end of cord 106 such that the plug 108 may be inserted into a wall outlet 110, such as a standard wall outlet in a home or garage, to provide electrical power to the power module 100. The cord 106 and plug 108 may be replaced by wiring that is hard wired to the power source such as a building's electrical system.

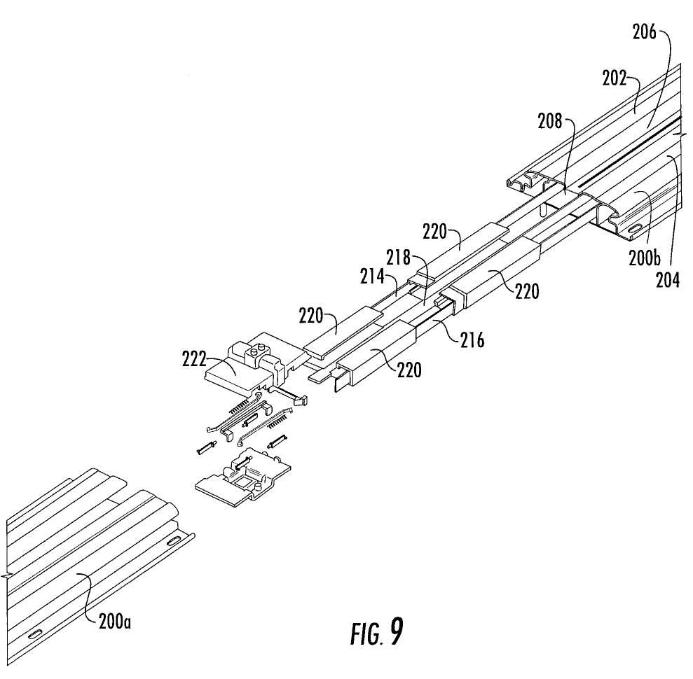

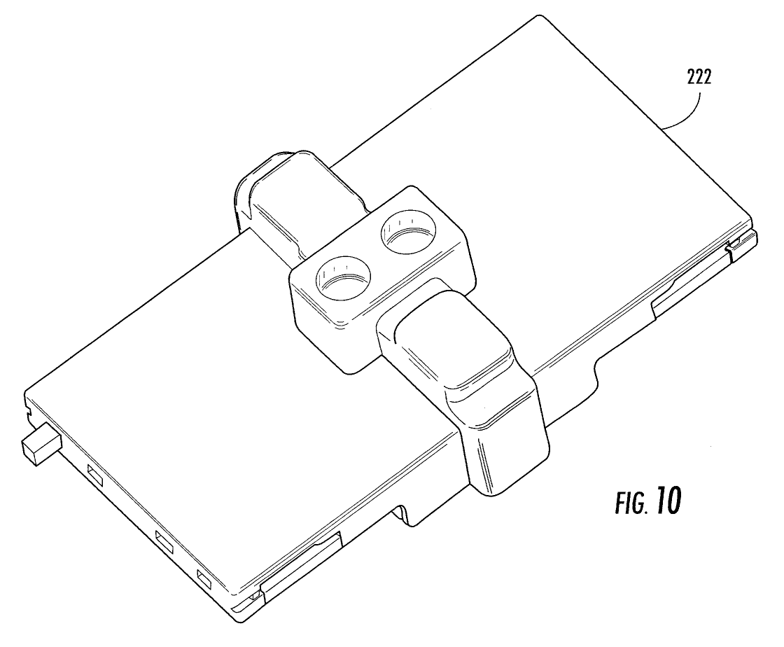

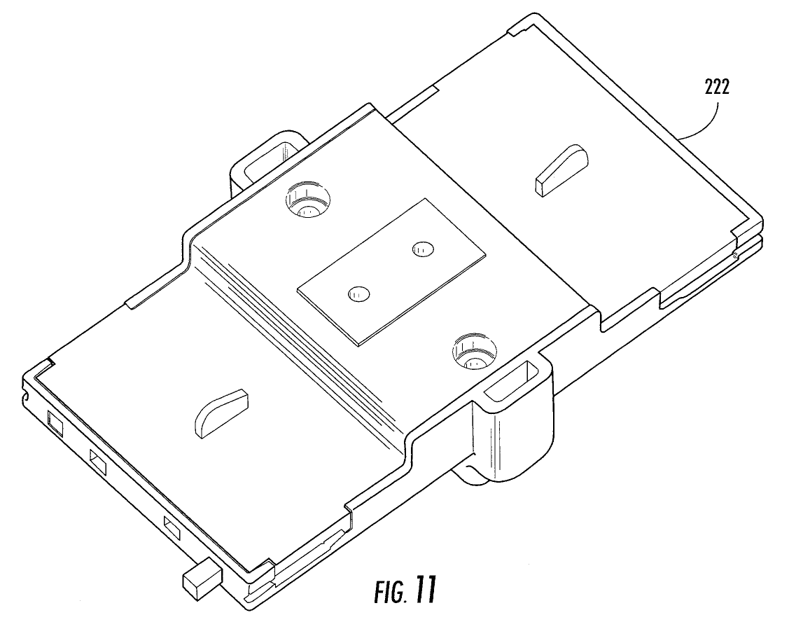

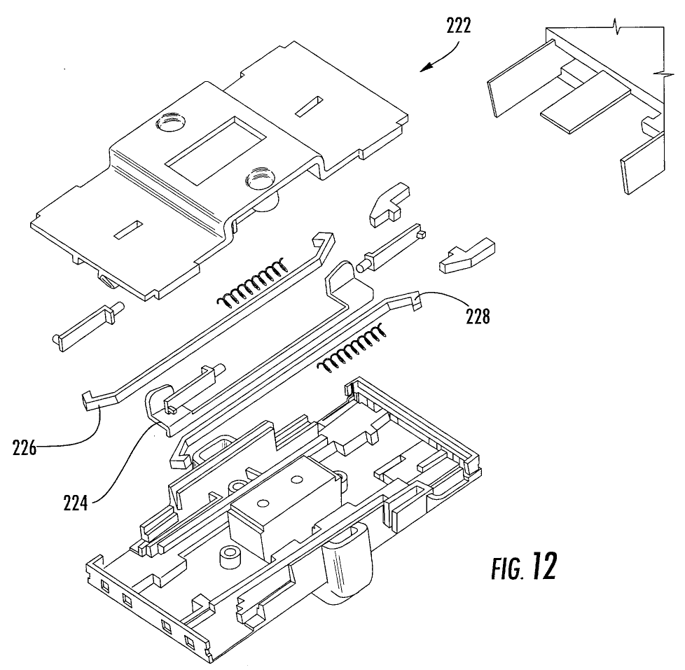

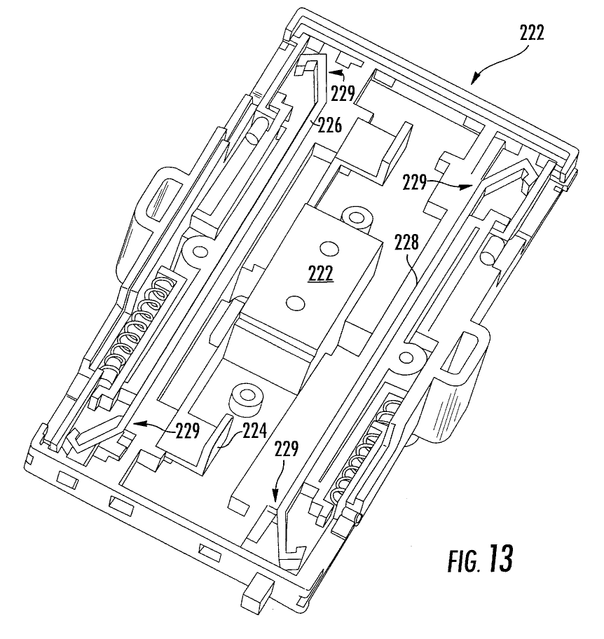

An alternate embodiment of a rail supporting electrically powered accessories is shown in FIGS. 8 through 22. Referring to FIG. 8, in this embodiment the rail 200 includes a flat back portion 201 supporting an upper flange assembly 202 and a lower flange assembly 204 where the flange assemblies are space from one another to create a gap 206 between the flange assemblies that leads to an internal space 208. Gap 206 and space 208 extend for the length of the rail. The upper and lower flange assemblies 202 and 204 may be identical such that the rail is symmetrical about its longitudinal axis. This symmetry allows the rail to be mounted on a vertical surface with either edge facing upwards and allows the rail to be mounted on a ceiling where ceiling mounted accessories can be suspended from the rail.

Each of flange assemblies 202 and 204 define a recess 210 between the flanges 212 and the back portion 201. The flanges 212 are engaged by gripping members formed on mating accessories, as will hereinafter be described, such that the accessory can be mounted to the rail 200 with the flange assemblies 202 and 204 gripped therebetween.

Referring to FIG. 9, located within the space 208 are electrical conductors 214, 216 and 218. Conductor 214 is located in flange assembly 202, conductor 216 is located in flange assembly 204 and center conductor 218 is located opposite gap 206 on the back portion 201. Suitable insulating casings 220 are provided to electrically isolate the electrical conductors from the rail such that current flowing in conductors 214, 216 and 218 is not conducted to the rail 200.

While the conductors are shown as being located inside of the rail, the conductors may extend above or below the rail and could be mounted in a separate housing that extends parallel to the rail. In such an arrangement the accessories may be connected to the conductors using a “pig tail” type connector.

Referring to FIGS. 9 through 14 an electrical connector 222 is provided between rail segments such as rail segments 200a and 200b such that segments of the rail may be electrically connected to one another such that power provided to one rail segment may be transmitted to adjacent rail segments. Connector 222 fits into the open ends of the adjacent rail segments 200a and 200b. Referring to FIG. 13, connector 222 includes a first conductor 224 for electrically coupling the central conductor 218 of the adjacent rail segments to one another; a second conductor 226 for electrically coupling the conductors 214 of the adjacent rail segments to one another; and a third conductor 228 for electrically coupling the conductors 216 of the adjacent rail segments to one another.

The connector 222 may include safety mechanism 229 to prevent the conductors 214 and 216 from being contacted by a person if one end of the connector is connected to a live rail and the other end of the connector is exposed. The safety mechanisms normally bias a cover to shield the conductors from the external environment. The covers are moved to allow access to the conductors when the connector is inserted in a rail.

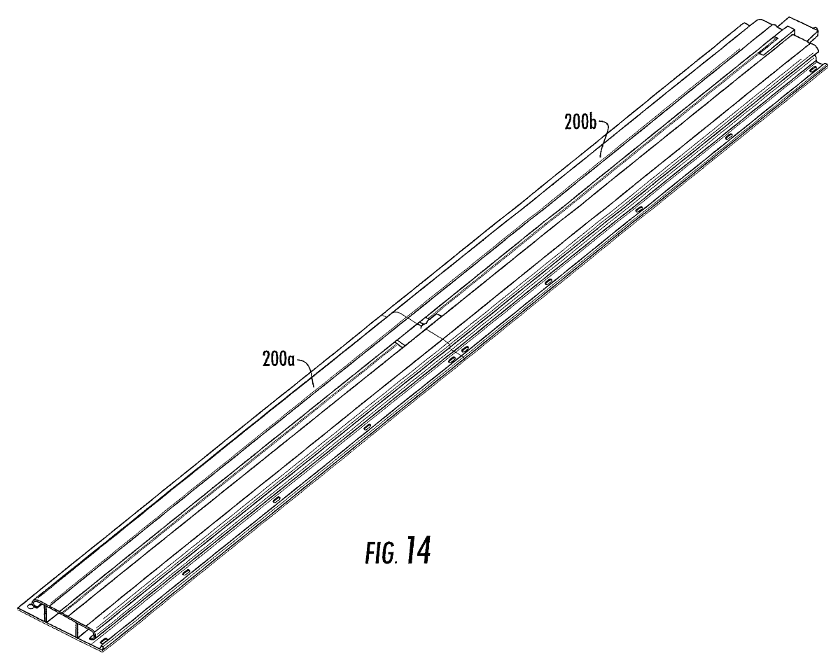

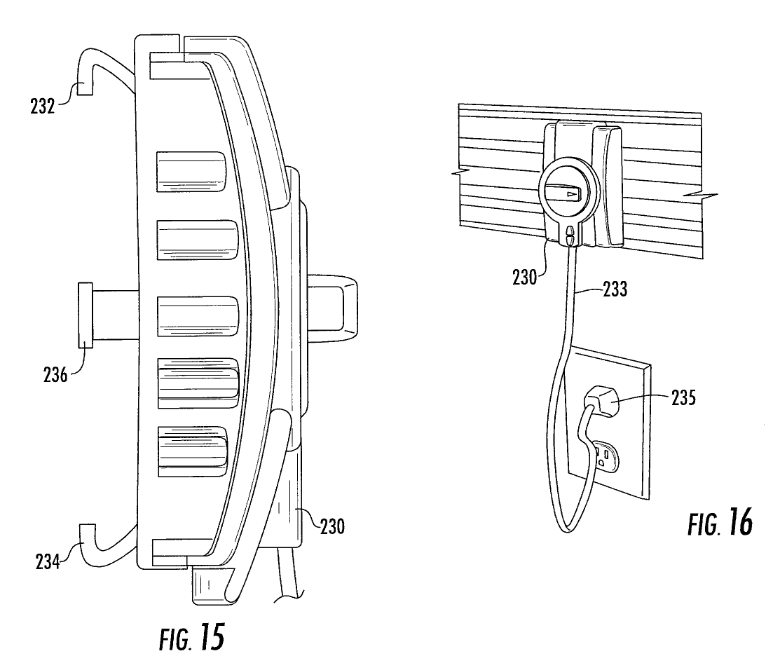

Power may be provided to the rail by a power module such as shown in FIGS. 15 and 16. The power module 230, shown in FIG. 15, is mounted to the rail in essentially the same manner that an accessory is mounted to the rail. Specifically, power module 230 includes gripping members 232 and 234 that can grip the flanges 212 of the rail 200 to retain the power module 230 on the rail. The power module 230 further includes at least one conductor that electrically couples the power module to the conductors 214, 216 and 218 located in the rail. In the illustrated embodiment conductor 236 is inserted into space 208 via gap 206 so as to make contact with conductors 214, 216 and 218 and provide power thereto. An electrical conductor such as cord 233 having a plug 235 formed at the end thereof is electrically coupled to an outlet 4. The plug 235 may be inserted into a wall outlet, such as a standard wall outlet in a home or garage, to provide electrical power to the power module 230. The cord 233 and plug 235 may be replaced by wiring that is hard wired to a power source such as a building's electrical system.

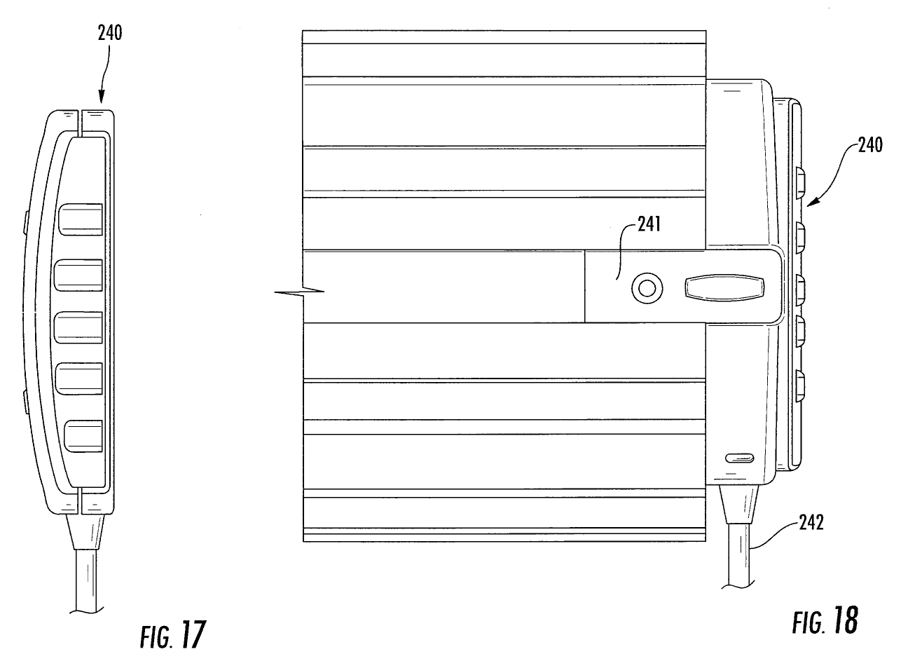

An alternate power module 240 shown in FIGS. 17 and 18 that includes a male connector 241 that is inserted into the open end of the rail (rather than being mounted on the rail like an accessory) and includes electrical contacts for contacting conductors 214, 216 and 218 to provide power to the conductors. An electrical conductor such as a cord 242 having a plug formed at the end thereof is electrically coupled to an outlet as explained with reference to the embodiment of FIG. 15. The cord and plug may be replaced by wiring that is hard wired to a power source such as a building's electrical system.

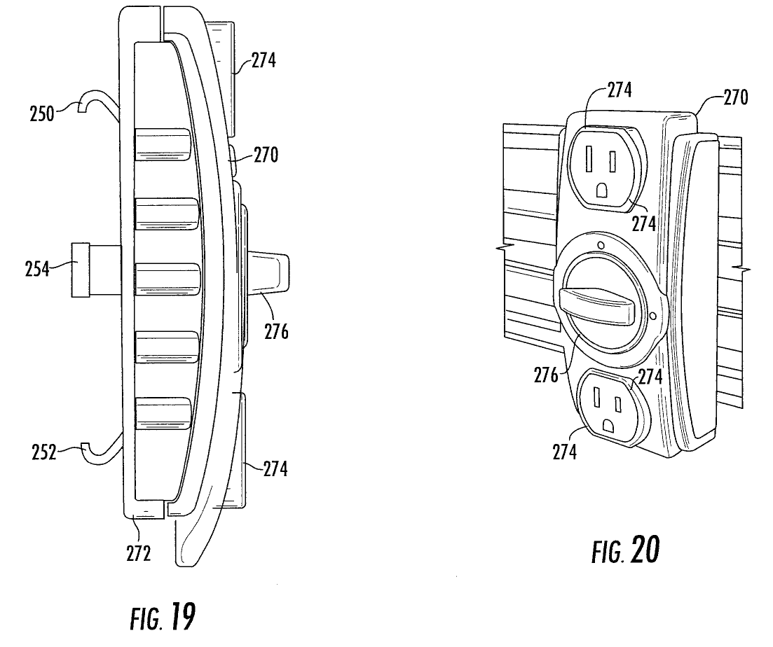

Example accessories for mounting on the powered rail are shown in FIGS. 19 through 25. Referring to FIG. 19, the accessories all mount to the rail in essentially the same manner and include a first gripping member 250 for engaging the first flange assembly 202 and a second gripping member 252 for engaging the second flange assembly 204 such that the flange assemblies are trapped between and gripped by the gripping members. The gripping members 250 and 252 may be made resilient such that the gripping members are flexed as they are inserted over the rail 200 to create a gripping force on the flange assemblies 202 and 204. Each accessory further includes a conductor 254 for contacting the conductors 214, 216 and 218 located in the rail 200 to thereby provide power to the accessory. In the illustrated embodiments the conductor 254 is comprised of a post that can be inserted through gap 206 and into space 208 to contact the conductors.

FIG. 19 shows a power strip 270 that has a housing 272 that supports a plurality of outlets or sockets 274. In the illustrated embodiment, the sockets 274 are arranged in the front of housing 272 although the sockets 274 may be arranged in any position on the housing 272 provided that they can be accessed by a mating plug. The outlets or sockets 274 are able to receive mating standard plugs from electrical appliances such as extension cords, tools, lights or any other device that requires a source of electrical power. The power strip 270 may include a switch 276 to open and close the electrical circuit between the source of power and the outlets 274 to turn the outlets on and off. Each outlet 274 may also be individually switched. The power strip 270 may have built in surge protectors. Housing 272 supports the conductor 254 and gripping members 250 and 252.

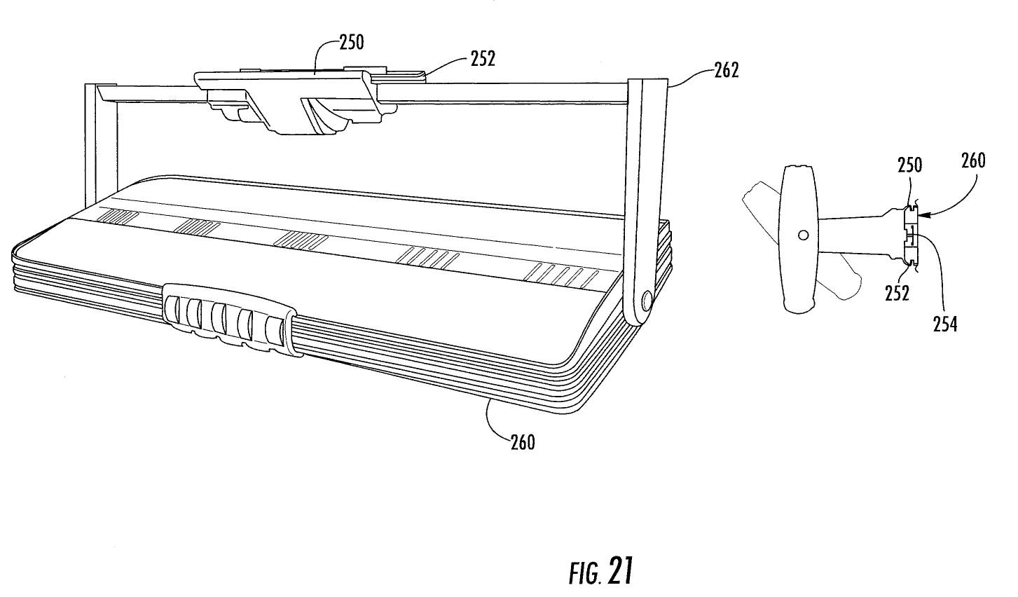

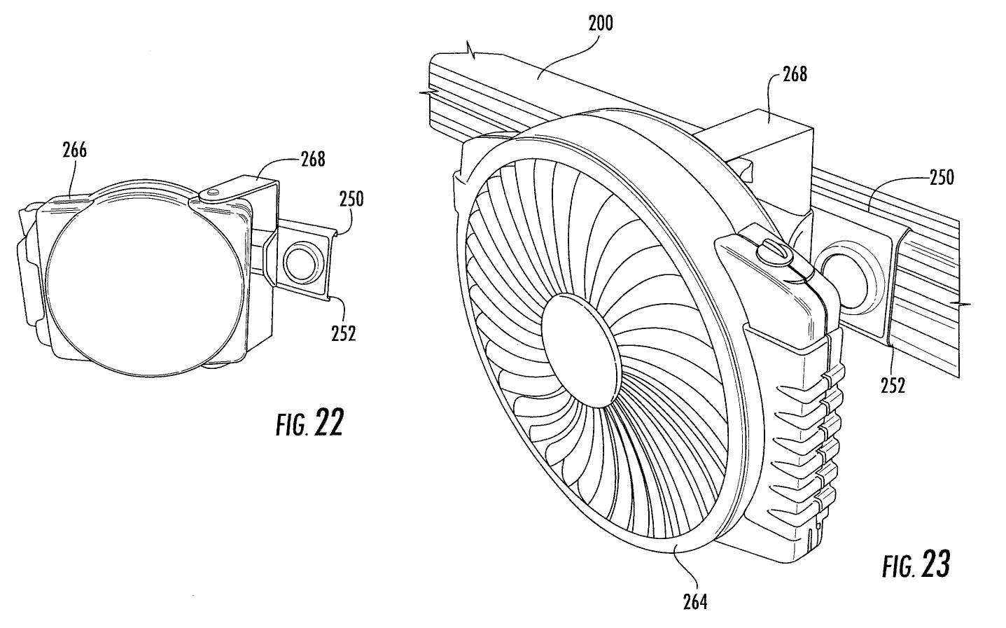

FIG. 20 shows a fluorescent light 260 that may be pivotably mounted on an arm assembly 262 where the arm assembly includes the gripping members 250 and 252 and conductor 254. Similarly FIG. 22 shows a fan 264 and FIG. 21 shows an extension cord 266 that are also pivotably mounted on arm assemblies 268 and 270, respectively, where the arm assemblies include the conductor 254 and gripping members 250 and 252.

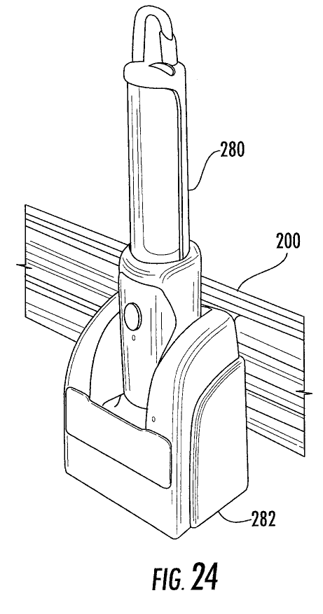

FIG. 23 shows a rechargeable light 280 where the charger 282 is mounted on the rail 200 using the conductor 254 and gripping members 250 and 252 as previously described. The light 280 may be removably mounted in the charger 282 to recharge a battery in the light as is known.

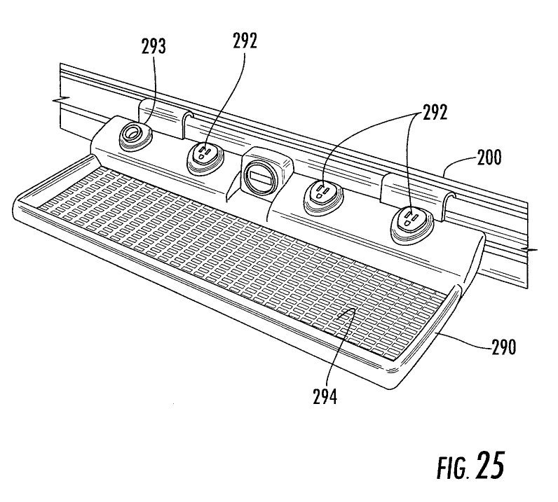

FIGS. 24 and 25 also shows a charging station 290 connected to the rail that can be used to charge batteries from electrical appliances or tools. The charging station 290 includes electrical outlets 292 for receiving the plug from the battery charger of the tool or appliance and may include a DC adapter 293. The charging station further includes a platform 294 on which the battery chargers, tools, appliances be placed during the charging operation. A first gripping member 250 for engaging the first flange assembly 202 and a second gripping member 252 for engaging the second flange assembly 204 are provided to the rear of the platform 294. Conductor 254 is provided for contacting the conductors 214, 216 and 218 located in the rail 200 to thereby provide power to the accessory. The accessories shown in FIGS. 19 through 25 may also be provided with a cord and powered using the power strip as shown in FIGS. 6 and 7. Numerous other electrically powered accessories may be mounted on the rail in addition to those specifically described herein.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A power rail system comprising:
a rail for mounting on a surface;
a device for providing power to the rail; and
an accessory for releasably engaging the rail, said accessory using the power provided to the rail to power the accessory.

2. The system of claim 1 wherein said rail supports at least one storage accessory.

3. The system of claim 1 wherein said device for providing power to the rail comprises a power strip releasably mounted on the rail.

4. The system of claim 3 wherein said power strip includes at least one outlet.

5. The system of claim 4 wherein said accessory plugs into said outlet.

6. The system of claim 4 wherein said power strip includes a plug for being electrically connected to a power source.

7. The system of claim 3 wherein said power strip can be repositioned along the length of the rail.

8. The system of claim 4 wherein said accessory is a light.

9. The system of claim 4 wherein said accessory is an extension cord.

10. The system of claim 4 wherein said accessory is a charging station.

11. The system of claim 4 wherein said accessory is a fan.

12. The system of claim 1 wherein said rail includes a first rail segment and a second rail segment, said device for providing power to the rail comprising a power strip located between the first rail segment and the second rail segment.

13. The system of claim 1 wherein said device for providing power to the rail includes an electrical conductor extending along a length of the rail.

14. The system of claim 13 wherein said electrical conductor is powered by a power module that connects to the rail.

15. The system of claim 14 wherein said power module includes a connector that may be connected to a source of power.

16. The system of claim 13 wherein said power module creates an electrical path between the source of power and the electrical conductor.

17. The system of claim 13 wherein said accessory is electrically connected to said electrical conductor when said accessory is mounted on said rail.

18. The system of claim 13 wherein said accessory is a light.

19. The system of claim 13 wherein said accessory is an extension cord.

20. The system of claim 13 wherein said accessory is a charging station.

21. The system of claim 13 wherein said accessory is a fan.

22. A rail for use in a storage system comprising:
a back portion;
a flange extending from said back portion for supporting an accessory on said rail;
an electrical conductor extending along a length of the rail, said electrical conductor being connectable to a source of power to provide power to said rail.

23. The rail of claim 22 further including a second flange such that said accessory engages the flange and the second flange.

24. The rail of claim 23 wherein said flange and said second flange are space from one another to create a gap between the flange and the second flange.

25. The rail of claim 23 wherein said flange and said second flange are identical such that the rail is symmetrical about its longitudinal axis.

26. The rail of claim 24 wherein said electrical conductor is located in said gap.

27. The rail of claim 22 wherein said rail includes an internal space, said electrical conductor being located in said internal space.

28. The rail of claim 23 said flange and said second flange each define a recess such that the flange and second flange are engaged by gripping members formed on the accessory.

29. The rail of claim 22 wherein insulating casings electrically isolate the electrical conductor from the rail.

30. The rail of claim 22 wherein said rail includes a first rail segment and a second rail segment, an electrical connector is provided between the first rail segment and the second rail such that first rail segment is electrically connected to the second rail segment such that power provided to one rail segment may be transmitted to the other segment.

31. The rail of claim 22 wherein said electrical connector fits into an open end of the first rail segment and the second rail.

32. A power strip for use in a system comprising a rail, said rail adapted to support a plurality of storage accessories, said power strip comprising:
a housing having means for connecting the housing to the rail;
at least one power outlet supported on the housing;
and an electrical connector for connecting the power outlet to a power source.

33. A method of storing and powering accessories comprising:
mounting a rail on a surface;
providing power to the rail;
releasably mounting an accessory on the rail and connecting said accessory to the power provided to the rail; and
releasably mounting a storage accessory on the rail.
